(19) United States
(12) Patent Application Publication
(10) Pub. No.: US 2013/0240154 A1
(43) Pub. Date: Sep. 19, 2013

(54) WINCH POWERED TIRE BEAD BREAKER

(71) Applicants: Mark G. Gallup, Rosemary (CA); Gordon L. Gallup, Rosemary (CA)

(72) Inventors: Mark G. Gallup, Rosemary (CA); Gordon L. Gallup, Rosemary (CA)

(21) Appl. No.: 13/423,412

(22) Filed: Mar. 19, 2012

(51) Int. Cl. B60C 25/13; B23P 11/00

(52) U.S. Cl. 157/1.26; 157/1.1

(57) ABSTRACT

A tire bead breaker, used when mounted on a winch which is mounted on an ATV, to squeeze a tire seated on a rim, said winch having a hook ended cable extending between two vertical rollers carried on a winch frame, comprising: an inner and an outer arm, each arm having a one end portion pivoted to the other arm, and an opposite end portion carrying one of two opposing wheel jaws; wherein the inner arm has a central portion adapted to seat against the vertical rollers on a front portion of the winch, and a winch attachment means to hang and maintain the tire bead breaker in an operable position in front of the winch.

### FIELD OF THE INVENTION

This invention relates to the removal of a tire seated on the rim of a wheel. More particularly this invention relates to a tire bead breaker which is powered by a winch mounted on a vehicle. When the tire bead breaker is mounted on and in front of a winch which is mounted on a vehicle the wheel may be rolled into an operable position between its jaws.

### BACKGROUND OF THE INVENTION

Removal of a tire which is seated on the rim of a wheel is a difficult task without the use of specialized equipment. Probably the most difficult step in the process is the first step which is “breaking the bead” or unseating the tire from the rim of the wheel. Many ranchers, farmers, and ATV (an All Terrain Vehicle) enthusiasts have a winch mounted on an ATV or four wheel drive vehicle. A tire shop frequently is not nearby, or even open when a tire must be repaired. There is a need for a lightweight winch powered bead breaker which can be used to break the bead of a tire mounted on a wheel with the winch mounted on an ATV.

### OBJECTS OF THE INVENTION

It is an object of this invention to disclose a winch powered tire bead breaker. It is an object of this invention to disclose a lightweight and portable tire bead breaker which can be quickly mounted on a winch which is mounted on a vehicle so that a tire can be conveniently rolled into an operable position between its jaws. It is an object of this invention to disclose a means to remove a tire when a tire shop is either unavailable or closed. Frequently quad enthusiasts recreate in remote locations. For many farmers and ranchers, rural tire shops are a substantial distance away and only open on weekdays. It is yet a further object of this invention to disclose a lightweight tire bead breaker which can be powered and is operatively positioned on a winch mounted on an ATV, or even a much smaller recreational quad type vehicle. It is an object of this invention to disclose a relatively lightweight and inexpensive tire bead breaker which is practical to use anywhere on an ATV having a winch.

One aspect of this invention provides for a tire bead breaker, used when mounted on a winch which is mounted on an ATV, to squeeze a tire seated on a rim, said winch having a hook ended cable extending between two vertical rollers carried on a winch frame, comprising: an inner and an outer arm, each arm having a one end portion pivoted to the other arm, and an opposite end portion carrying one of two opposing wheel jaws; wherein the inner arm has a central portion adapted to seat against the vertical rollers on a front portion of the winch, and a winch attachment means to hang and maintain the tire bead breaker in an operable position in front of the winch.

In a preferred aspect of this invention the winch attachment means comprises a hinged clasp having, i) a hook ended clasp end portion for hanging on and over the frame of the winch, ii) a hinge to facilitate hooking the hook ended clasp end portion over the frame of the winch when the bead breaker has an outer side portion in a raised mounting position, and iii) a bolted opposite end portion attached to elongated holes in the bead breaker to facilitate adjusted spacing of the hinged clasp from different winches having varying lateral spacing from a front side portion thereof to their frames, to thereby adjust for, and maintain the bead breaker in a horizontal operably mounted position on a particular winch.

Yet another aspect of this invention comprises a method of unseating a tire from a rim comprising the following steps: a) obtaining a tire bead breaker as described in claim 4; b) positioning and aligning the inner arm of the bead breaker against the vertical rollers on a front portion of the winch mounted on the ATV, said bead breaker having its outer side portion tipped upwardly from a horizontal position; c) to thereby facilitate hanging the hook ended clasp end portion over the frame of the winch; d) lowering the outer side portion of the bead breaker to thereby have the bead breaker hang in a horizontal operable position in front of the winch; e) attaching the hook ended cable of the winch to the hook reception notch on an external side of the outer arm of the bead breaker; f) rolling and positioning a wheel between the jaws of the bead breaker wherein the wheel jaw on the inner arm is in alignment with, and supporting the rim of the wheel; g) winding in the hook ended cable thereby squeezing the wheel and breaking the tire from and off of the rim.

Various other objects, advantages and features of this invention will become apparent to those skilled in the art from the following description in conjunction with the accompanying drawings.

### FIGURES OF THE INVENTION

FIG. 1 is a perspective view of a tire bead breaker for use with an ATV having a winch.

FIG. 2 is a perspective view of the tire bead breaker shown in FIG. 1. It is mounted on a winch which is mounted on the front of an ATV. A wheel is mounted between the jaws of the tire bead breaker.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

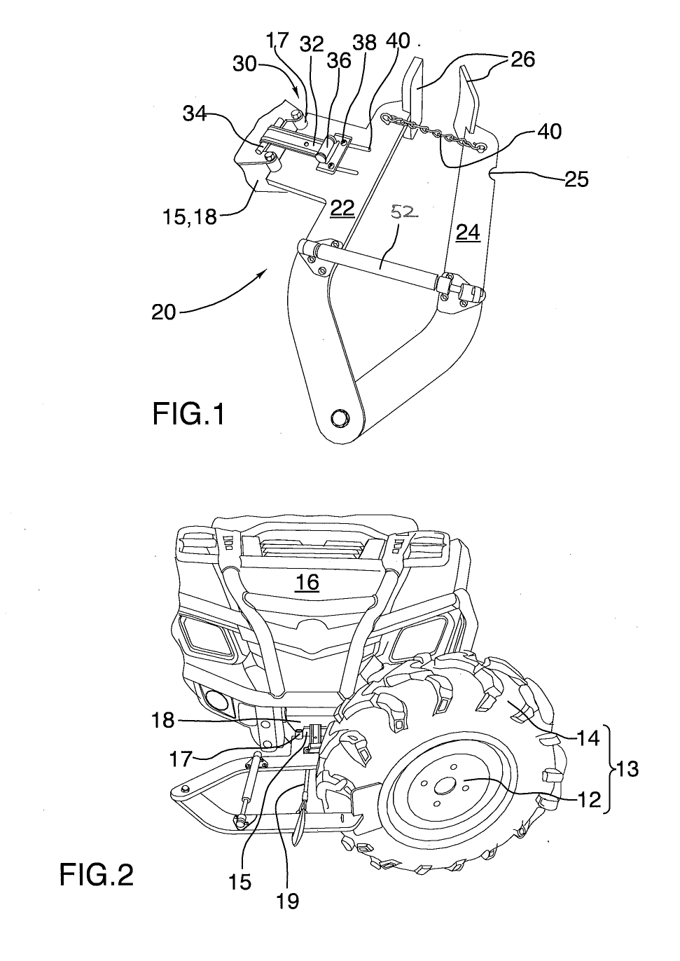

Turning now to the drawings and more particularly to FIG. 1 we have a perspective view of a tire bead breaker 20 for use with an ATV 16 having a winch 18. FIG. 2 is a perspective view of the tire bead breaker 20 shown in FIG. 1, mounted on a winch 18 which is mounted on the front of an ATV 16. A wheel 13 is mounted between the jaws 26 of the tire bead breaker 20. Most generally a tire bead breaker 20 is used when mounted on a winch 18 which is mounted on an ATV 16, to squeeze a tire 14 seated on a rim 12, said winch 18 having a hook ended cable 19 extending between two vertical rollers 17 carried on a winch frame 15, comprises: an inner arm 22 and an outer arm 24, each arm having a one end portion pivoted to the other arm 22,24, and an opposite end portion carrying one of two opposing wheel jaws 26. The inner arm 22 has a central portion adapted to seat against the vertical rollers 17 on a front portion of the winch 18, and a winch attachment means 30 to hang and maintain the tire bead breaker 20 in an operable position in front of the winch 18.

Most preferably, the tire bead breaker 20 is fabricated from flat plate. In the most preferred embodiment of the invention the tire bead breaker 20 further comprising an air shock 32, extending between pivot end portions of the arms 22,24, having an extended length just sufficient to space the jaws 26 apart sufficiently to slip over the tire 14, and biased to an open position, so that tension will be maintained on the hook ended cable 19 when it is attached to a central external portion of the outer arm 24 in a hook reception notch 25.

In the most preferred embodiment of the invention the winch attachment means 30 comprises a hinged clasp 32 having, i) a hook ended clasp end portion 34 for hanging on and over the frame 15 of the winch 18, ii) a hinge 36 to facilitate hooking the hook ended clasp end portion 34 over the frame 15 of the winch 18 when the bead breaker 20 has an outer side portion in a raised mounting position, and iii) a bolted opposite end portion 38 attached to elongated holes 40 in the bead breaker 20 to facilitate adjustment of the spacing of the hinged clasp 32 on different winches 18 having varying lateral spacing from a front side portion thereof to their frames 15, to thereby adjust for, and maintain the bead breaker 20 in a horizontal operably mounted position on a particular winch 18.

In the most preferred embodiment of the invention the jaw 26 attached to the inner arm 22 is configured to push against and support the rim 12, and wherein the jaw 26 attached to the outer arm 24 is configured to press on the tire 14, so that when the arms 22,24 squeeze together, the tire 14 will unseat from the rim 12, on a side adjacent to the outer arm 24. It is noted that after the tire 14 is released from the rim 12 on a side pressed against by the outer arm 24, it is necessary to first remove the wheel 13 from between the arms 22,24, and then to turn the wheel 13 so that the other unbroken bead between the tire 14 and the rim 12 is adjacent to the outer arm 24, to then to reposition the wheel 13 between the arms 22,24 to break the unbroken bead. In the most preferred embodiment of the invention the inclusion of a releasable closure chain 40 releasably extends and is attached between the jaws 26 to maintain the bead breaker 20 in a closed storage position.

A method of unseating a tire 14 from a rim 12 comprises the following steps: a) obtaining a tire bead breaker 20 as described above; b) positioning and aligning the inner arm 22 of the bead breaker 20 against the vertical rollers 17 on a front portion of the winch 18 mounted on the ATV 16, said bead breaker 20 having its outer side portion tipped upwardly from a horizontal position; c) to thereby facilitate hanging the hook ended clasp end portion 34 over the frame 15 of the winch 18; d) lowering the outer side portion of the bead breaker 20 to thereby have the bead breaker 20 hang in a horizontal operable position in front of the winch 18; e) attaching the hook ended cable 19 of the winch 18 to the hook reception notch 25 on an external side of the outer arm of the bead breaker 20; f) rolling and positioning a wheel 13 between the jaws 26 of the bead breaker 20 wherein the jaw 26 on the inner arm 22 is in alignment with, and supporting the rim 12 of the wheel 13; g) winding in the hook ended cable 19 thereby squeezing the wheel 13 and breaking the tire 14 from and off of the rim 12.

While the invention has been described with preferred specific embodiments thereof, it will be understood that this description is intended to illustrate and not to limit the scope of the invention, which is defined by the following claims.

1. A tire bead breaker, used when mounted on a winch which is mounted on an ATV, to squeeze a tire seated on a rim, said winch having a hook ended cable extending between two vertical rollers carried on a winch frame, comprising:
an inner and an outer arm, each arm having a one end portion pivoted to the other arm, and an opposite end portion carrying one of two opposing wheel jaws;
wherein the inner arm has a central portion adapted to seat against the vertical rollers on a front portion of the winch, and a winch attachment means to hang and maintain the tire bead breaker in an operable position in front of the winch, and
wherein the outer arm has a hook reception notch for receiving the hook ended cable.

2.-7. (canceled)
